(19) United States
(12) Patent Application Publication
(10) Pub. No.: US 2022/0300988 A1
(43) Pub. Date: Sep. 22, 2022

(54) LEVERAGING INDIVIDUAL ENGAGEMENT HISTORY IN ACCOUNT BASED PERSONALIZATION

(71) Applicant: salesforce.com, inc., San Francisco, CA (US)

(72) Inventors: Mehmet Orun, San Francisco, CA (US); Robert Phillips, Atlanta, GA (US)

(21) Appl. No.: 17/206,310

(22) Filed: Mar. 19, 2021

(51) Int. Cl. G06Q 30/02; G06Q 30/00; G06F 16/23

(52) U.S. Cl. CPC G06Q 30/0201; G06Q 30/016; G06F 16/2379

(57) ABSTRACT

Methods, computer readable media, and devices for leveraging individual engagement history in account-based marketing personalization are provided. One method may include receiving information identifying an individual associated with a first business and an interaction between the individual and a second business, creating a new entity contact record, determining a global party identifier to be associated with the new entity contact record, updating the new entity contact record to include the global party identifier, calculating a unified lead score indicating a propensity of the individual as a prospect based on the individual, the first business, and the interaction, updating the new entity contact record to include the unified lead score, and, if the global party identifier is associated with an additional entity contact record, recalculating the unified lead score based on the additional entity contact record and updating the new entity contact record with the recalculated unified lead score.

### TECHNICAL FIELD

Embodiments disclosed herein relate to techniques and systems for leveraging individual engagement history in account-based personalization of communications and other interactions with individuals and other entities. Embodiments disclosed herein may be used to reduce redundancy in user records and improve access to otherwise unavailable information.

### BACKGROUND

In a traditional approach to communications with individuals, a lead score, used to identify a propensity of a lead to engage and/or disengage with a business, may rely on an engagement history with a particular individual through a distinct contact point (e.g., email address) or as a business contact (e.g., person working at a particular company), where engagement may include capturing activities such as filling out forms, downloading white papers, clicking links tracked through digital mechanisms, or the like. However, such engagement history may not reflect the individual's complete interactions with the business, such as their interaction history across different partner or customer companies of the business that would indicate the individual's familiarity, influence, attitude towards the business' products or services that limit personalized interactions.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1 is a block diagram illustrating a sample data model used in conjunction with leveraging individual engagement history in account-based marketing personalization according to some example implementations.

FIG. 2 is a flow diagram illustrating a method for leveraging individual engagement history in account-based marketing personalization according to some example implementations.

FIG. 3A is a block diagram illustrating an electronic device according to some example implementations.

FIG. 3B is a block diagram of a deployment environment according to some example implementations.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

In a traditional business-to-business marketing use case, information describing an individual's engagement history with a business may be incomplete because the data leveraged to evaluate the individual's interest may be limited to interactions associated to a particular record that may have unintended duplicates, an individual may be identified strictly at a contact point such as their business email where other interactions may be missed, an individual's prior interactions with the business such as at a prior company may not be included, or data may not incorporate interactions of other individuals at the same company with the business that would prove a more holistic understanding of the interest. A current approach to account-based marketing may be to apply marketing strategies at the account level. However, this traditional account-based marketing response may include a few challenges that businesses continue to struggle with.

One challenge may be the definition of an account. For a client business with a single location, the need may be straightforward. However, many client businesses may have multiple locations, where needs of the client business may be location specific. A client business may be global, which means tracking based on an Internet Protocol (IP) address or some other digital addressing may be insufficient to capture company-wide digital engagement with a 360 understanding across all individuals of a company. A client business may have subsidiaries, where business decisions need to be made at a holding company or subsidiary level.

Another challenge may be incorporating an individual's awareness of a company's products and services into evaluation. In a traditional approach, when an individual who may be intimately familiar with a company's offerings moves from Account A to Account B, where accounts represent different companies or subsidiaries, the evaluation of that business contact starts as if there is no interaction history with the individual. While there may be a need to maintain firewalls of historical transactions of a past company and new transactions with the present company, lead knowledge and interest should be understood as a whole.

Yet a further challenge may be not incorporating individual influence in the probability of a client business's purchase interest. If a person who was previously an advocate or opponent of offerings leaves their current company, this should inform sales teams on how they may need to engage with the overall account marketing engagement. Knowing that an individual now has a different business contact role may imply change in a prior company even if prior company email messages did not bounce.

In a traditional implementation, such as a customer relationship management (CRM) system, conventional engagement tracking may require significant resources to match known entities, such as prior customers, with seemingly new contacts that are actually prior customers in order to reduce redundancy. In some cases such matching and reduction may not be possible, leading to additional use of computer resources.

In various implementations of the disclosed subject matter, an individual's engagement history that encompasses a more complete history of the individual may be leveraged to provide greater personalization of account based marketing. Such enhanced engagement history may be developed based on three tiers of understanding. For example, one tier may include an understanding of and distinguishing an individual from a role they play, particularly as a business contact, at different client businesses, while also understanding the client business' company hierarchy to recognize whether the individual has moved to a subsidiary or a different company. Another tier, for example, may include an ability to recognize different lead records as belonging to the same business contact or associated with the same client business, to increase the effectiveness of business contact lead scores. Still another tier, for example, may include being able to link individual leads across different business contact relationships to allow for a new lead's score to be influenced by the overall individual business relationship history, so a person who joins a new company may have a higher lead score if they were a previous customer as an advocate. Based on these three tiers, a business may, for example, identify an individual as having an engagement history greater than the individual's current role at a current client business. In turn, the business may, for example, leverage this enhanced engagement history to further personalize marketing efforts directed to the individual.

Implementations of the disclosed subject matter provide methods, computer readable media, and devices for leveraging individual engagement history in account-based marketing personalization. In various implementations, a method may include receiving, in a customer relationship management (CRM) system, information identifying an individual associated with a first business and an interaction between the individual and a second business, creating a new entity contact record that may include the information identifying the individual, information identifying the first business, and the information identifying the interaction, determining a global party identifier to be associated with the new entity contact record, updating the new entity contact record to include the global party identifier, calculating a unified lead score, indicating a propensity of the individual as a prospect, based on the individual, the first business, and the interaction, updating the new entity contact record to include the unified lead score, and in response to determining that the global party identifier is associated with an additional entity contact record, recalculating the unified lead score based on the additional entity contact record and updating the new entity contact record with the recalculated unified lead score.

In some implementations, determining the global party identifier to be associated with the new entity contact record may include determining whether the individual is associated with an individual global profile record and, in response to determining that the individual is associated with an individual global profile record, retrieving the global party identifier from the individual global profile record associated with the individual.

In some implementations, determining the global party identifier to be associated with the new entity contact record may include determining whether the individual is associated with an individual global profile record and, in response to determining that the individual is not associated with an individual global profile record, creating a new individual global profile record comprising a new global party identifier, associating the individual with the new global profile record, and identifying the new global party identifier as the global party identifier to be associated with the new entity contact record.

In various implementations, the unified lead score may be a numerical value generated based on a plurality of context scores, including one or more context scores based on the information identifying the individual, one or more context scores based on the information identifying the first business, and one or more context scores based on the information identifying the interaction.

In various implementations, recalculating the unified lead score based on the additional entity contact record may include identifying the additional entity contact record based on the global party identifier, determining a plurality of context scores, and recalculating the unified lead score based on the plurality of context scores. In some implementations, the additional entity contact record may include additional information identifying the individual, information identifying an additional business, and information identifying one or more additional interactions between the individual and the second business. In some implementations, one or more of the plurality of context scores may be based on the additional information identifying the individual, one or more of the plurality of context scores may be based on the information identifying the additional business, and one or more of the plurality of context scores may be based on the information identifying the one or more additional interactions between the individual and the second business.

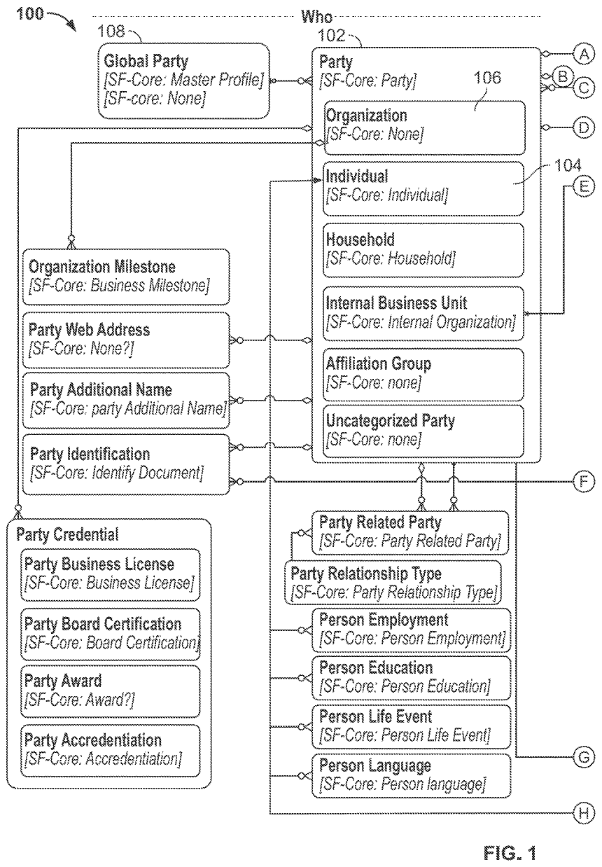

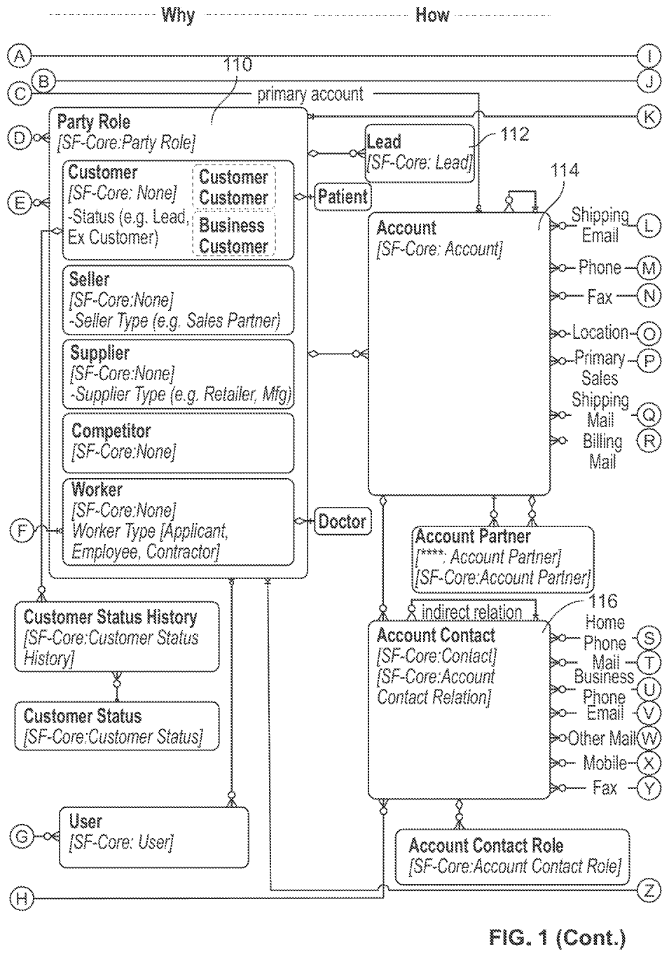

FIG. 1 illustrates a data model 100 for use in conjunction with leveraging individual engagement history in account-based marketing personalization. In various implementations, the data model 100 may include, for example, a party record 102, a party role record 110, a lead record 112, an account record 114, an account contact record 116, a contact point record 118, a global party record 108, and/or one or more additional records as shown in FIG. 1. In some implementations, party record 102 may include, for example, an organization field 106, an individual field 104, and/or one or more additional fields. Although data model 100 only shows a single example of each record, this is only for simplicity. In practice, a database, datastore, or other platform based on such data model may include a multitude of records of each type. In various implementations, such database, datastore, or other platform may be utilized by a business providing products and/or services to individuals and/or organizations and such business may utilize data model 100 to facilitate marketing efforts.

In various implementations, individual field 104 may define an individual (e.g., the individual's name) and organization field 106 may define an organization with which the individual may be currently or previously associated with. As such, party record 102 may define, for example, a relationship between an individual and an organization and such relationship may be current (e.g., individual currently employed by organization) or may be historical in nature (e.g., individual was previously employed by organization). Party role record 110 may, for example, define a role performed by the individual identified in party record 102.

In various implementations, global party record 108 may include, for example, a global party identifier that may be a unique identifier to be associated with an individual. For example, while party record 102 may define one relationship between an individual, as indicated in individual field 104, and an organization, as indicated in organization field 106, an additional party record may define another relationship between the same individual and a different organization. By associating the same global party record 108, using the global party identifier, with both party records, data model 100 enables identification of one individual as having relationships with one or more organizations. For example, a business utilizing data model 100 to facilitate marketing efforts may be able to develop a richer engagement history of an individual across multiple organizations and/or multiple roles based on the global party identifier.

In various implementations, lead record 112 may define whether a role represents a marketing lead, account record 114 may define an account with which a party and a party role are associated, and account contact record 116 may define an individual as a contact for an account. For example, the combination of lead record 112, account record 114, and account contact record 116 may enable a business to identify whether an organization (as indicated in organization field 106 of party record 102), represented by an individual (as indicated in individual field 104 of party record 102), is a client (based on account record 114 and account contact record 116) and/or a lead (based on lead record 112). Based on the combination of lead record 112, account record 114, and contact record 116, a business may be informed about how to interact with an individual and/or an organization.

In various implementations, contact point record 118 may define one or more methods via which an individual and/or an organization has established contact with a business. By identifying these contact methods, a business may be informed about how to communicate with the individual and/or the organization in the future.

As can be seen in FIG. 1, data model 100 enables an enhanced engagement history based on three tiers of understanding as discussed above. For example, global party record 108, party record 102, and party role record 110 may enable an understanding of and distinguishing an individual from a role they play at different client organizations while also understanding a client organization's hierarchy to recognize whether the individual has moved to a subsidiary or a different organization. In this example, lead record 112, account record 114, and account contact record 116 may enable an ability to recognize different lead records as belonging to the same individual and/or associated with the same client organization in order to increase the effectiveness of business contact lead scores. Further in this example, global party record 108, along with the various other records, may enable the ability to link individual leads across different organization contact relationships to allow for a new lead's score to be influenced by the overall relationship history of an individual, so that an individual who joins a new organization may have a higher lead score if that individual was a previous customer as an advocate. Based on data model 100 and a method as discussed in greater detail below, a business may identify an individual as having an engagement history greater than the individual's current role at a current organization. In turn, the business may, for example, leverage this enhanced engagement history to further personalize marketing efforts directed to the individual.

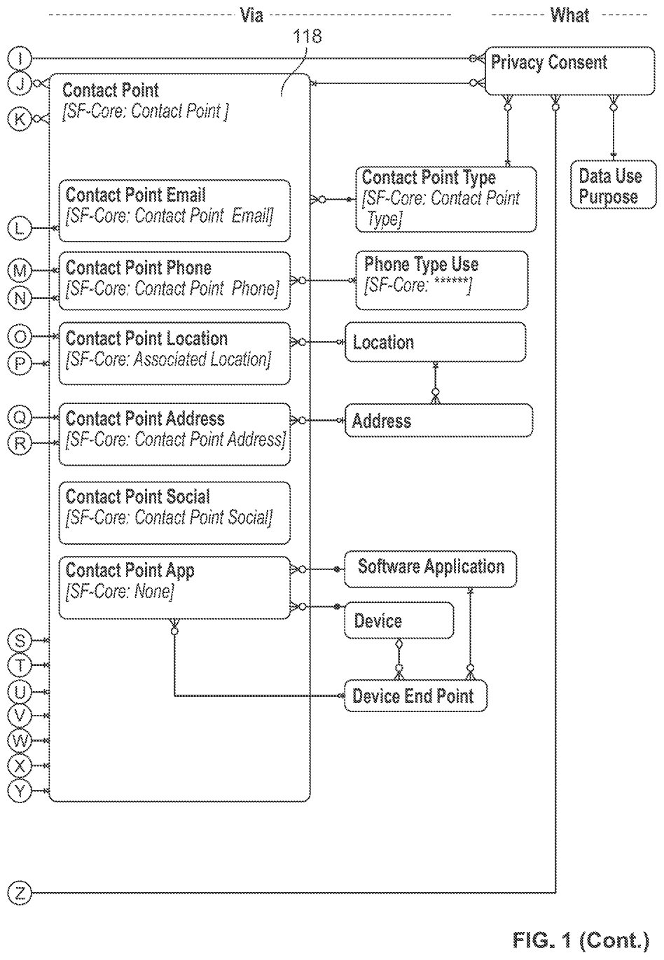

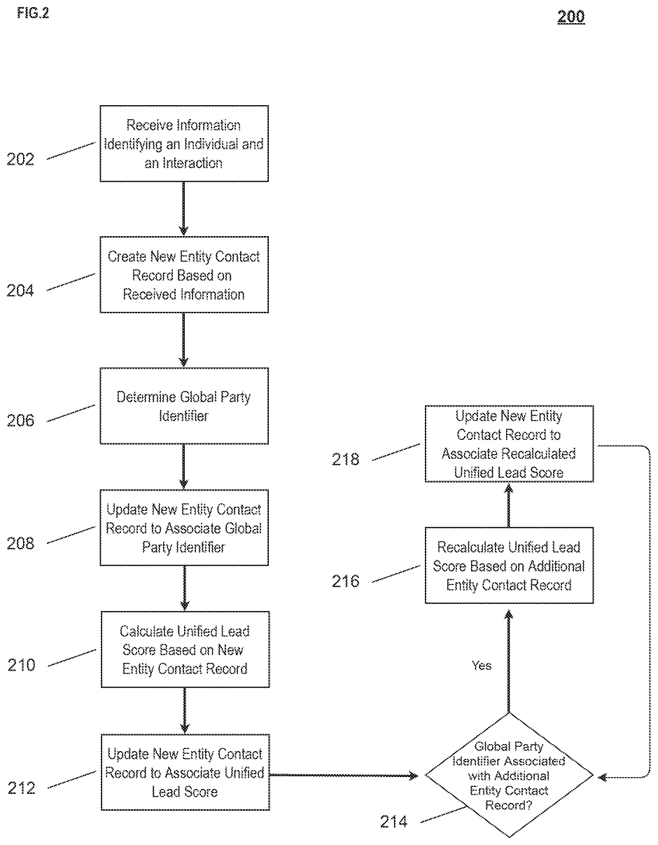

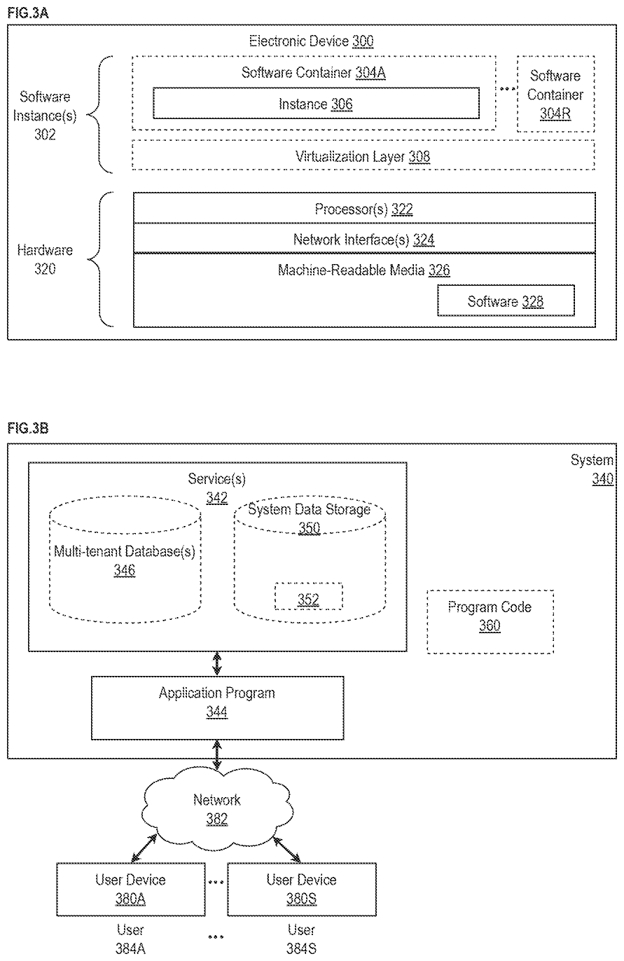

FIG. 2 illustrates a method 200 for leveraging individual engagement history in account-based marketing personalization, as disclosed herein. In various implementations, the steps of method 200 may be performed by a server, such as electronic device 300 of FIG. 3A or system 340 of FIG. 3B, and/or by software executing on a server or distributed computing platform. Although the steps of method 200 are presented in a particular order, this is only for simplicity.

In step 202, information identifying an individual and an interaction may be received. For example, an individual may request a white paper, complete a contact form, and/or otherwise initiate an interaction with a business. In various implementations, the individual may be associated with an organization and the business may be a business that provides one or more products and/or services to the organization and/or the individual. More generally, the individual and the interaction may be considered a lead by the business and the information received may define or otherwise describe the lead. The information received may include, for example, information identifying the individual, information identifying an organization with which the individual is associated, and/or information identifying the interaction.

In step 204, a new entity contact record may be created based on the received information. For example, a new party record, as described in relation to FIG. 1 above, may be created. Such entity contact record may include, for example, the information identifying the individual and the information identifying the organization with which the individual is associated.

In step 206, a global party identifier may be determined. For example, global profile records, as described in relation to FIG. 1 above, may be searched to determine whether a global profile for the individual already exists. If a global profile for the individual already exists (i.e., the individual had previously interacted with the business), the global party identifier may be an identifier associated with that global profile. However, if a global profile for the individual does not exist (i.e., the individual has not previously interacted with the business), a new global profile may be created and the global party identifier may be a new identifier associated with the new global profile.

In step 208, the new entity contact record may be updated to associate the global party identifier with the record. For example, the record may be updated to include the global party identifier as determined in step 206.

In step 210, a unified lead score may be calculated based on the new entity contact record. In various implementations, a unified lead score may be a numerical value that indicates a propensity of the individual as a prospect. Such unified lead score may be calculated, for example, based solely on the current interaction and/or based on information related to or otherwise defined by the individual's current association with the organization with which the individual is currently associated. That is, such unified lead score may be based on a limited engagement history of the individual.

In step 212, the new entity contact record may be updated to associate the unified lead score with the record. For example, the record may be updated to include the unified lead score.

In determination step 214, it may be determined whether the global party identifier is associated with an additional entity contact record. If the global party identifier is associated with an additional entity contact record (i.e., determination step 214=“Yes”), the method may proceed to step 216.

In step 216, the unified lead score may be recalculated based on the additional entity contact record. In various implementations, the additional entity contact record may define or otherwise provide information about an association of the individual with a different organization or within a different role with the organization. That is, the additional entity contact record may provide additional engagement history information regarding the individual, either within a different role with the organization or with a different organization. As such, the recalculated unified lead score may be based on a more complete engagement history of the individual.

In step 218, the new entity contact record may be updated to associate the recalculated unified lead score with the record. For example, the previously calculated unified lead score in the record may be replaced with the recalculated unified lead score.

As shown in FIG. 2, determination step 214, step 216, and step 218 may be repeatedly performed for any additional entity contact records that may exist for the individual. In this way, the unified lead score associated with the new entity contact record may reflect an enhanced engagement history of the individual that takes into account not only the current interaction and interactions of the individual while associated with their current organization, but also interactions of the individual while associated with other organizations. This unified lead score that encompasses an enhanced engagement history may be leveraged to provide enhanced personalization of account-based marketing.

Embodiments disclosed herein may improve the efficiency of communications between entities, such as business and individuals. For example, by using a unified lead score as disclosed herein, a business may be able to more efficiently and effectively engage with a prospect while utilizing fewer resources.

Furthermore, embodiments disclosed herein may provide improvements to the underlying computer systems in which they are implemented, such as CRM systems. For example, conventional engagement tracking may require significant resources to match known entities, such as prior customers, with seemingly new contacts that are actually prior customers in order to reduce redundancy. In some cases, such matching and reduction may not be possible, leading to additional use of computer resources. In contrast, embodiments disclosed herein provide an approach to identify multiple interactions as belonging to a single individual, which can lead to improved efficiency within the CRM system as well as requiring fewer computing resources, electronic storage, and the like.

The various issues addressed by the embodiments disclosed herein arise due to the increasing use of electronic marketing and communications, which allow individuals to have multiple personas that appear different within a computer system. The disclosed subject matter solves these issues by providing a mechanism to identify multiple personas as belonging to a single individual.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

FIG. 3A is a block diagram illustrating an electronic device 300 according to some example implementations. FIG. 3A includes hardware 320 comprising a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and consolidated order manager may be implemented in one or more electronic devices 300.

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including a consolidated order manager. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 340 is a multi-tenant cloud computing architecture supporting multiple services, such as one or more of the following types of services: Customer relationship management (CRM); Configure, price, quote (CPQ); Business process modeling (BPM); Customer support; Marketing; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 340 may include an application platform 344 that enables PAAS for creating, managing, and executing one or more applications developed by the provider of the application platform 344, users accessing the system 340 via one or more of user devices 380A-380S, or third-party application developers accessing the system 340 via one or more of user devices 380A-380S.

In some implementations, one or more of the service(s) 342 may use one or more multi-tenant databases 346, as well as system data storage 350 for system data 352 accessible to system 340. In certain implementations, the system 340 includes a set of one or more servers that are running on server electronic devices and that are configured to handle requests for any authorized user associated with any tenant (there is no server affinity for a user and/or tenant to a specific server). The user devices 380A-380S communicate with the server(s) of system 340 to request and update tenant-level data and system-level data hosted by system 340, and in response the system 340 (e.g., one or more servers in system 340) automatically may generate one or more Structured Query Language (SQL) statements (e.g., one or more SQL queries) that are designed to access the desired information from the multi-tenant database(s) 346 and/or system data storage 350.

In some implementations, the service(s) 342 are implemented using virtual applications dynamically created at run time responsive to queries from the user devices 380A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 344 includes an application setup mechanism that supports application developers' creation and management of applications, which may be saved as metadata by save routines. Invocations to such applications, including the framework for modeling heterogeneous feature sets, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device can be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer-implemented method comprising:
receiving, in a customer relationship management (CRM) system, information identifying an individual and an interaction between the individual and a second business, the individual being associated with a first business;
creating a new entity contact record, the new entity contact record comprising:
the information identifying the individual;
information identifying the first business; and
the information identifying the interaction;
determining a global party identifier to be associated with the new entity contact record;
updating the new entity contact record to further comprise the global party identifier;
calculating a unified lead score based on the individual, the first business, and the interaction, wherein the unified lead score indicates a propensity of the individual as a prospect;
updating the new entity contact record to further comprise the unified lead score; and
in response to determining that the global party identifier is associated with an additional entity contact record:
recalculating the unified lead score based on the additional entity contact record; and
updating the new entity contact record with the recalculated unified lead score.

2. The computer-implemented method of claim 1, wherein determining the global party identifier to be associated with the new entity contact record comprises:
determining whether the individual is associated with an individual global profile record; and
in response to determining that the individual is associated with an individual global profile record, retrieving the global party identifier from the individual global profile record associated with the individual.

3. The computer-implemented method of claim 1, wherein determining the global party identifier to be associated with the new entity contact record comprises:
determining whether the individual is associated with an individual global profile record; and
in response to determining that the individual is not associated with an individual global profile record:
creating a new individual global profile record comprising a new global party identifier;
associating the individual with the new global profile record; and
identifying the new global party identifier as the global party identifier to be associated with the new entity contact record.

4. The computer-implemented method of claim 1, wherein the unified lead score is a numerical value generated based on a plurality of context scores, wherein:
one or more of the plurality of context scores is based on the information identifying the individual;
one or more of the plurality of context scores is based on the information identifying the first business; and
one or more of the plurality of context scores is based on the information identifying the interaction.

5. The computer-implemented method of claim 1, wherein recalculating the unified lead score based on the additional entity contact record comprises:
identifying the additional entity contact record based on the global party identifier, wherein the additional entity contact record comprises:
additional information identifying the individual;
information identifying an additional business; and
information identifying one or more additional interactions between the individual and the second business;
determining a plurality of context scores, wherein:
one or more of the plurality of context scores is based on the additional information identifying the individual;
one or more of the plurality of context scores is based on the information identifying the additional business; and
one or more of the plurality of context scores is based on the information identifying the one or more additional interactions between the individual and the second business; and
recalculating the unified lead score based on the plurality of context scores.

6. A non-transitory machine-readable storage medium that provides instructions that, if executed by a processor, are configurable to cause the processor to perform operations comprising:
receiving, in a customer relationship management (CRM) system, information identifying an individual and an interaction between the individual and a second business, the individual being associated with a first business;
creating a new entity contact record, the new entity contact record comprising:
the information identifying the individual;
information identifying the first business; and
the information identifying the interaction;
determining a global party identifier to be associated with the new entity contact record;
updating the new entity contact record to further comprise the global party identifier;
calculating a unified lead score based on the individual, the first business, and the interaction, wherein the unified lead score indicates a propensity of the individual as a prospect;
updating the new entity contact record to further comprise the unified lead score; and
in response to determining that the global party identifier is associated with an additional entity contact record:
recalculating the unified lead score based on the additional entity contact record; and
updating the new entity contact record with the recalculated unified lead score.

7. The non-transitory machine-readable storage medium of claim 6, wherein determining the global party identifier to be associated with the new entity contact record comprises:
determining whether the individual is associated with an individual global profile record; and
in response to determining that the individual is associated with an individual global profile record, retrieving the global party identifier from the individual global profile record associated with the individual.

8. The non-transitory machine-readable storage medium of claim 6, wherein determining the global party identifier to be associated with the new entity contact record comprises:
determining whether the individual is associated with an individual global profile record; and
in response to determining that the individual is not associated with an individual global profile record:
creating a new individual global profile record comprising a new global party identifier;
associating the individual with the new global profile record; and
identifying the new global party identifier as the global party identifier to be associated with the new entity contact record.

9. The non-transitory machine-readable storage medium of claim 6, wherein the unified lead score is a numerical value generated based on a plurality of context scores, wherein:
one or more of the plurality of context scores is based on the information identifying the individual;
one or more of the plurality of context scores is based on the information identifying the first business; and
one or more of the plurality of context scores is based on the information identifying the interaction.

10. The non-transitory machine-readable storage medium of claim 6, wherein recalculating the unified lead score based on the additional entity contact record comprises:
identifying the additional entity contact record based on the global party identifier, wherein the additional entity contact record comprises:
additional information identifying the individual;
information identifying an additional business; and
information identifying one or more additional interactions between the individual and the second business;
determining a plurality of context scores, wherein:
one or more of the plurality of context scores is based on the additional information identifying the individual;
one or more of the plurality of context scores is based on the information identifying the additional business; and
one or more of the plurality of context scores is based on the information identifying the one or more additional interactions between the individual and the second business; and
recalculating the unified lead score based on the plurality of context scores.

11. An apparatus comprising:
a processor; and
a non-transitory machine-readable storage medium that provides instructions that, if executed by a processor, are configurable to cause the processor to perform operations comprising:
receiving, in a customer relationship management (CRM) system, information identifying an individual and an interaction between the individual and a second business, the individual being associated with a first business;
creating a new entity contact record, the new entity contact record comprising:
the information identifying the individual;
information identifying the first business; and
the information identifying the interaction;
determining a global party identifier to be associated with the new entity contact record;
updating the new entity contact record to further comprise the global party identifier;
calculating a unified lead score based on the individual, the first business, and the interaction, wherein the unified lead score indicates a propensity of the individual as a prospect;
updating the new entity contact record to further comprise the unified lead score; and
in response to determining that the global party identifier is associated with an additional entity contact record:
recalculating the unified lead score based on the additional entity contact record; and
updating the new entity contact record with the recalculated unified lead score.

12. The apparatus of claim 11, wherein determining the global party identifier to be associated with the new entity contact record comprises:
determining whether the individual is associated with an individual global profile record; and
in response to determining that the individual is associated with an individual global profile record, retrieving the global party identifier from the individual global profile record associated with the individual.

13. The apparatus of claim 11, wherein determining the global party identifier to be associated with the new entity contact record comprises:
determining whether the individual is associated with an individual global profile record; and
in response to determining that the individual is not associated with an individual global profile record:
creating a new individual global profile record comprising a new global party identifier;
associating the individual with the new global profile record; and
identifying the new global party identifier as the global party identifier to be associated with the new entity contact record.

14. The apparatus of claim 11, wherein the unified lead score is a numerical value generated based on a plurality of context scores, wherein:
one or more of the plurality of context scores is based on the information identifying the individual;
one or more of the plurality of context scores is based on the information identifying the first business; and
one or more of the plurality of context scores is based on the information identifying the interaction.

15. The apparatus of claim 11, wherein recalculating the unified lead score based on the additional entity contact record comprises:
identifying the additional entity contact record based on the global party identifier, wherein the additional entity contact record comprises:
additional information identifying the individual;
information identifying an additional business; and
information identifying one or more additional interactions between the individual and the second business;
determining a plurality of context scores, wherein:
one or more of the plurality of context scores is based on the additional information identifying the individual;
one or more of the plurality of context scores is based on the information identifying the additional business; and
one or more of the plurality of context scores is based on the information identifying the one or more additional interactions between the individual and the second business; and
recalculating the unified lead score based on the plurality of context scores.
